(19) United States
(12) Patent Application Publication
(10) Pub. No.: US 2013/0163415 A1
(43) Pub. Date: Jun. 27, 2013

(54) APPARATUS AND METHOD FOR DISTRIBUTING A LOAD AMONG A PLURALITY OF COMMUNICATION DEVICES

(71) Applicant: Fujitsu Limited, Kawasaki-shi (JP)

(72) Inventors: Yoshiaki Kikkawa, Kawasaki (JP); Akira Chugo, Kawasaki (JP); Kouichi Takase, Meguro (JP)

(73) Assignee: Fujitsu Limited, Kawasaki-shi (JP)

(21) Appl. No.: 13/680,640

(22) Filed: Nov. 19, 2012

(30) Foreign Application Priority Data
Dec. 22, 2011 (JP) 2011-282101

(51) Int. Cl. H04L 12/56

(52) U.S. Cl. CPC H04L 47/10
USPC 370/229

(57) ABSTRACT

An apparatus distributes a load among a plurality of communication devices. The apparatus stores a session information management table that stores session information for a request packet in association with one of the plurality of communication devices via which the request packet has been transmitted to the apparatus. The apparatus receives a first response packet in response to a first request packet that has been transmitted via a first communication device included in the plurality of communication devices where the first response packet sharing first session information with the first request packet. The apparatus selects, from among the plurality of communication devices, the first communication device associated with the first session information, by referring to the session information management table, and transmits the first response packet to the selected first communication device.

### CROSS-REFERENCE TO RELATED APPLICATION

This application is based upon and claims the benefit of priority of the prior Japanese Patent Application No. 2011-282101, filed on Dec. 22, 2011, the entire contents of which are incorporated herein by reference.

### FIELD

The embodiment discussed herein is related to an apparatus and method for distributing a load among a plurality of communication devices.

### BACKGROUND

With increase in communication traffic, for example, due to wide use of large-capacity and high-speed communication, cases increase where traffic processing performance of a communication device, such as a firewall, installed at a boundary with an external network becomes a bottleneck for communication.

In order to handle the cases, a plurality of communication devices, such as a plurality of firewalls, are installed so as to distribute a load to the plurality of communication devices.

FIG. 1 is a schematic diagram illustrating an example of a conventional system for distributing a load. FIG. 1 illustrates an example in which a request packet is transmitted from a node 1201-1 to a node 1201-2 and a response packet is transmitted from the node 1201-2 to the node 1201-1 in response to the request packet.

The request packet transmitted from the node 1201-1 reaches a load balancer (LB) 1401-1 through the Internet 1601 and a router 1301-1.

The LB 1401-1 uses an arbitrary load distribution algorithm to select, from among firewalls (FWs) 1501-1 to 1501-3, a firewall (FW) to which the request packet is to be distributed. Then, the LB 1401-1 transmits the request packet to the selected firewall. In this example, it is assumed that the LB 1401-1 transmits the request packet to the FW 1501-1.

The FW 1501-1 performs packet check processing on the request packet based on an address of the transmitting node 1201-1 and a port of the transmitting node 1201-1 to determine whether to permit the request packet to pass through the FW 1501-1.

When there is no problem with the result of checking the request packet, the FW 1501-1 permits the request packet to pass through the FW 1501-1, that is, transmits the request packet to an LB 1401-2. When session information on the request packet is not registered yet, the FW 1501-1 adds the session information to a session information table. When the session information on the request packet has already been registered, the FW 1501-1 updates the session information registered in the session information table.

The FW 1501-1 transmits the added or updated session information to the FWs 1501-2 and 1501-3. The FWs 1501-2 and 1501-3 reflect the received session information in session information management tables held by the FWs 1501-2 and 1501-3, respectively. Thus, the pieces of session information held by the FWs 1501-1 to 1501-3 are synchronized, and the FWs 1501-1 to 1501-3 have the same session information.

The request packet that has passed through the FW 1501-1 passes through the LB 1401-2 and a router 1301-2 and reaches the node 1201-2. The node 1201-2 transmits, to the node 1201-1, a response packet in response to the received request packet. The transmitted response packet reaches the LB 1401-2 through the router 1301-2.

The LB 1401-2 selects, from among the FWs 1501-1 to 1501-3, a firewall to which the response packet is to be distributed, using an arbitrary load distribution algorithm. Then, the LB 1401-2 transmits the response packet to the selected firewall. In this example, it is assumes that the LB 1401-2 transmits the response packet to the FW 1501-3. The FW 1501-3 performs packet check processing on the response packet to determine whether to permit the response packet to pass through the FW 1501-3.

Next, description will be given of packet check processing that is performed on the response packet. The FW 1501-3 performs the packet check processing to determine whether a backward packet (or the response packet) responsive to a forward packet (or the request packet) that has been permitted to pass through the FW 1501-1 is permitted to pass through the FW 1501-3.

For example, the FW 1501-3 references the session information table held by the FW 1501-3 and determines whether to permit the response packet to pass through the FW 1501-3, by determining whether or not the session information corresponding to the response packet has been registered in the session information table thereof.

When there is no problem with the result of the packet check processing, the FW 1501-3 permits the response packet to pass through the FW 1501-3, that is, transmits the response packet to the LB 1401-1. The response packet reaches the node 1201-1 through the router 1301-1 and the Internet 1601.

Japanese Laid-open Patent Publications Nos. 2010-108479, 2004-350188 and 2007-312434 are examples of related art.

### SUMMARY

According to an aspect of the invention, an apparatus distributes load among a plurality of communication devices. The apparatus stores a session information management table that stores session information of a request packet in association with one of the plurality of communication devices via which the request packet has been transmitted to the apparatus. The apparatus receives a first response packet in response to a first request packet that has been transmitted via a first communication device included in the plurality of communication devices where the first response packet sharing first session information with the first request packet. The apparatus selects, from among the plurality of communication devices, the first communication device associated with the first session information, by referring to the session information management table, and transmits the first response packet to the selected first communication device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a conventional system for distributing a load;

FIG. 2 is a diagram illustrating a configuration example of a system, according to an embodiment;

FIG. 3 is a diagram illustrating configuration examples of a load balancer and a firewall, according to an embodiment;

FIG. 4 is a diagram illustrating an example of a session information management table, according to an embodiment;

FIG. 5 is a diagram illustrating an example of a device information table, according to an embodiment;

FIG. 6 is a diagram illustrating an example of a session information table, according to an embodiment;

FIGS. 7A and 7B are diagrams illustrating an example of an operational flowchart for a distribution process, according to an embodiment;

FIGS. 8A and 8B are diagrams each illustrating an example of a notification for updating session information, according to an embodiment;

FIG. 9 is a diagram illustrating an example of device information, according to an embodiment;

FIG. 10 is a diagram illustrating an example of an operational flowchart for a take-over process, according to an embodiment; and

FIG. 11 is a diagram illustrating an example of a hardware configuration of an information processing device, according to an embodiment.

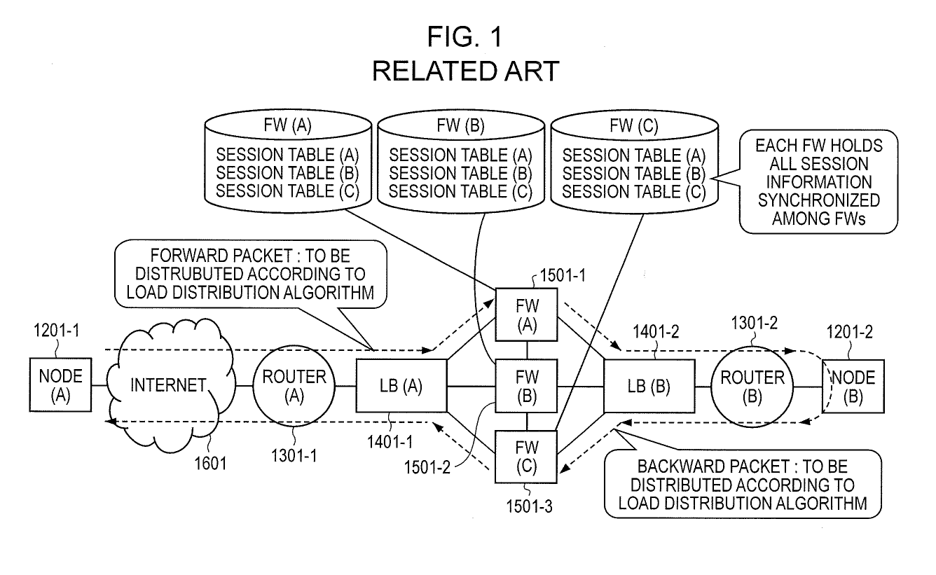

### DESCRIPTION OF EMBODIMENT

The conventional load balancers installed on both sides of the firewalls independently distribute loads in accordance with predetermined load distribution algorithms that are based on, for example, priorities, a round-robin processing, the minimum number of connections, the minimum number of clients, a CPU load, and a response time.

Therefore, a firewall through which a request packet (a forward packet) passes may be different from a firewall through which a response packet (a backward packet) passes in response to the request packet.

In the case, even when a response packet (a backward packet) responsive to a request packet (a forward packet) that has passed through a first firewall passes through a second firewall different from the first firewall, the second firewall performs packet check processing on the response packet. Therefore, session information held by the different firewalls, for example, first and second firewalls, need to be synchronized with each other.

However, in the case where the session information is synchronized among the firewalls, with increase in the number of sessions to be handled increases, the amount of memory to be used, the amount of update processing on session information, and a communication load for synchronizing session information increase. As a result, loads imposed on the firewalls increase, thereby disabling the firewalls from having sufficient resources.

Hereinafter, embodiments are described with reference to the accompanying drawings. In the embodiments, firewalls are used as exemplary communication devices to which a load is to be distributed.

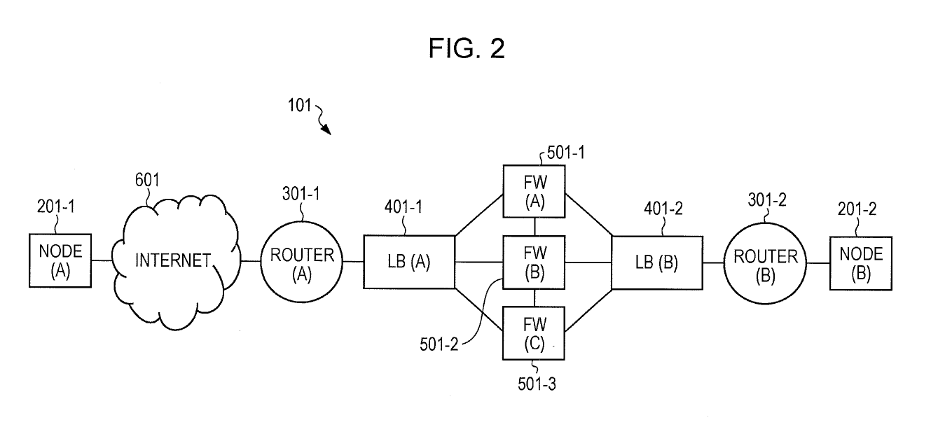

FIG. 2 is a diagram illustrating a configuration example of a system, according to an embodiment.

The system 101 includes nodes 201-1, 201-2, routers 301-1, 301-2, load balancers (LBs) 401-1, 401-2, and firewalls (FWs) 501-1, 501-2, 501-3. The nodes 201-1, 201-2 are devices that execute various processes and transmit and receive packets. The nodes 201-1, 201-2 are information processing devices, such as personal computers, servers, mobile phones, or mobile terminals. The node 201-1 is connected to the router 301-1 through the Internet 601. The node 201-2 is connected to the router 301-2.

In the following description and the drawings, the nodes 201-1 and 201-2 will be also referred to as a node (A) and a node (B), respectively. The router 301-1 and 301-2 are communication devices that relay data to other networks or devices. The router 301-1 is connected to the node 201-1 through the Internet 601 and connected to the LB 401-1. The router 301-2 is connected to the node 201-2 and the LB 401-2.

In the following description and the drawings, routers 301-1 and 301-2 will be also referred to as a router (A) and a router (B), respectively. FWs 501-1 to 501-3 will be also referred to as FWs 501, and any one of the FWs 501-1 to 501-3 will be also referred to as a FW 501. The LB 401-1 distributes a packet received from the router 301-1 to one of the FWs 501, and transmits a packet received from a FW 501 to the router 301-1, while the LB 401-2 distributes a packet received from the router 301-2 to one of the FWs 501 and transmits a packet received from a FW 501 to the router 301-2. The LB 401-1 is connected to the router 301-1 and the FWs 501-1 to 501-3. The LB 401-2 is connected to the router 301-2 and the FWs 501-1 to 501-3.

In the following description and the drawings, the LBs 401-1 and 401-2 will be also referred to as an LB (A) and an LB (B), respectively. A FW 501 causes the received packet to pass through the FW 501 or discards the received packet, in accordance with the requirement. A FW 501 is connected to the LBs 401-1 and 401-2. In the following description and the drawings, the FWs 501-1, 501-2, and 501-3 will be also referred to as an FW (A), an FW (B), and an FW (C), respectively.

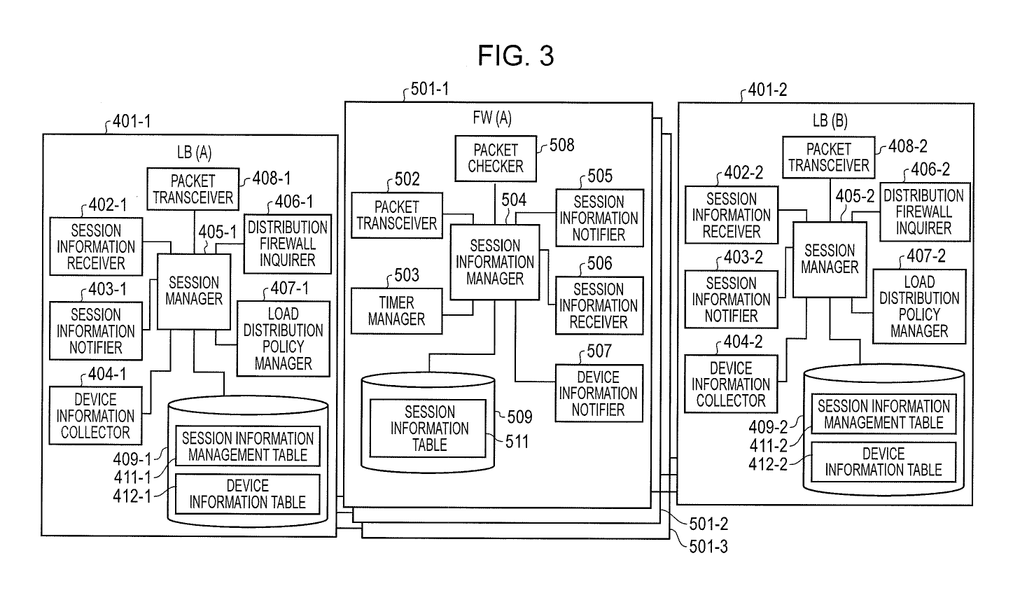

FIG. 3 is a diagram illustrating configuration examples of a load balancer and a firewall, according to an embodiment. In FIG. 3, the LBs 401-1 and 402-1 have the same configuration. Thus, the LB 401-1 is described below and the description of the LB 401-2 is omitted here.

The LB 401-1 may be configured to include a session information receiver 402-1, a session information notifier 403-1, a device information collector 404-1, a session manager 405-1, a distribution firewall (FW) inquirer 406-1, a load distribution policy manager 407-1, a packet transceiver 408-1, and a storage unit 409-1.

The session information receiver 402-1 receives session information from a FW 501. The session information notifier 403-1 notifies a FW 501 of session information.

The device information collector 404-1 periodically collects device information from a FW 501. The device information collector 404-1 writes the collected device information in a device information table thereof. Details of the device information will be described later.

The session manager 405-1 manages the session information received from a FW 501 and updates a session information management table 411-1 thereof. The distribution firewall (FW) inquirer 406-1 searches the session information management table 411-1 to detect the FW 501 to which a packet is to be distributed.

The load distribution policy manager 407-1 determines, on the basis of a load distribution policy, the FW 501 to which the packet is to be distributed. The packet transceiver 408-1 transmits and receives a packet. The storage unit 409-1 includes the session information management table 411-1 and a device information table 412-1.

The storage unit 409-1 is a device for storing data. The storage unit 409-1 may be implemented using, for example, a magnetic disk device and a semiconductor storage device. Here, description will be given of the session information management table 411-1 and the device information table 412-1.

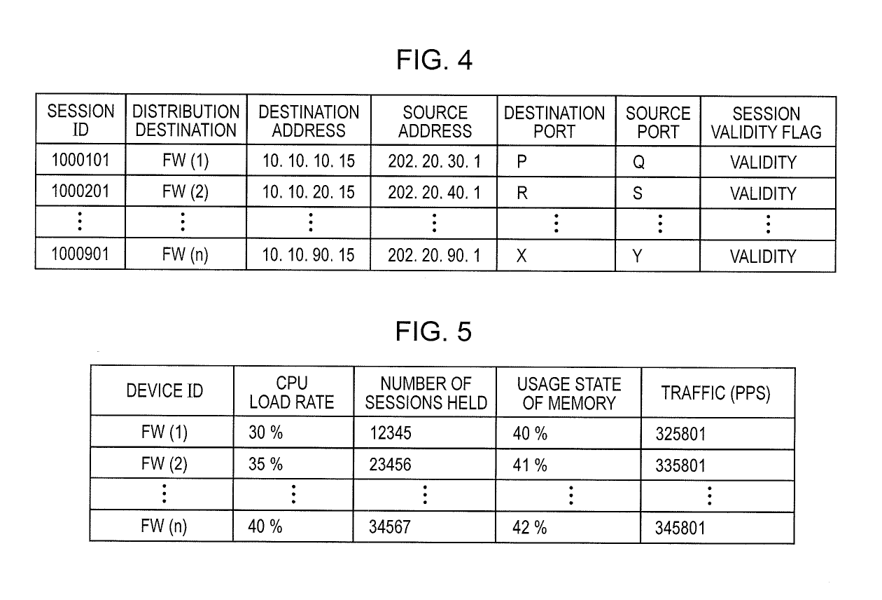

FIG. 4 is a diagram illustrating an example of a session information management table, according to an embodiment. The session information management table 411-1 has items for a session ID, a distribution destination, a destination addresses, a source addresses, a destination port, a source port, and a session validity flag.

The session ID is an identifier (ID) that identifies a session. The distribution destination is a firewall to which a packet is to be distributed. In the item of the distribution destination, an ID (an identifier) identifying the firewall to which the packet is to be distributed is stored.

The destination address is an IP address of a node that is a destination of the packet. The source address is an IP address of a node that is a source of the packet. The destination port is a port that is used by the node that is the destination of the packet. The source port is a port that is used by the node that is the source of the packet. The session validity flag indicates whether or not an session is valid. When the session validity flag indicates “validity”, the session validity flag indicates that the session is valid. When the session validity flag indicates “invalid”, the session validity flag indicates that the session is invalid.

FIG. 5 is a diagram illustrating an example of a device information table, according to an embodiment. The device information table 412-1 may be configured to include information items of a device ID, a CPU load rate, the number of sessions held, a usage state of memory, and traffic (PPS). The device ID is an ID (identifiers) identifying a firewall.

The CPU load rate indicates a usage rate of a central processing unit (CPU). The number of the sessions held is the numbers of the sessions held by the firewall. The usage status of memory indicates a usage rate of the memory.

The traffic (PPS) indicates the number of packets to be processed per 1 second. The unit of the traffic is a packet per second (PPS).

The LB 401-2 may be configured to include a session information receiver 402-2, a session information notifier 403-2, a device information collector 404-2, a session manager 405-2, a distribution firewall (FW) inquirer 406-2, a load distribution policy manager 407-2, a packet transceiver 408-2, and a storage unit 409-2. The storage unit 409-2 includes a session information management table 411-2 and a device information table 412-2.

The session information receiver 402-2, the session information notifier 403-2, the device information collector 404-2, the session manager 405-2, the distribution firewall (FW) inquirer 406-2, the load distribution policy manager 407-2, the packet transceiver 408-2, the storage unit 409-2, a session information management table 411-2, and a device information table 412-2 of the LB 401-2 have the same functions or configurations as the session information receiver 402-1, the session information notifier 403-1, the device information collector 404-1, the session manager 405-1, the distribution firewall (FW) inquirer 406-1, the load distribution policy manager 407-1, the packet transceiver 408-1, the storage unit 409-1, the session information management table 411-1, and the device information table 412-1 of the LB 401-1, respectively, and a description thereof is omitted here.

The FW 501-1 may be configured to include a packet transceiver 502, a timer manager 503, a session information manager 504, a session information notifier 505, a session information receiver 506, a device information notifier 507, a packet checker 508, and a storage unit 509.

The packet transceiver 502 transmits and receives a packet. The timer manager 503 manages a time period during which a record stored in a session information table 511 is valid. The session information manager 504 performs update processing, such as generation and deletion of a record, on the records in the session information table 511. The session information notifier 505 notifies the LB 401 of session information. The session information receiver 506 receives session information.

The device information notifier 507 notifies the LB 401 of device information where the device information includes a device ID, a CPU load rate, the number of sessions held, and the amount of traffic. The packet checker 508 checks whether a received packet is permitted to pass through the FW 501. When the received packet is not permitted to pass through the FW 501, the packet checker 508 discards the received packet.

The storage unit 509 includes the session information table 511. The storage unit 509 is a device for storing data. The storage unit 509 may be implemented using, for example, a magnetic disk device, or a semiconductor storage device.

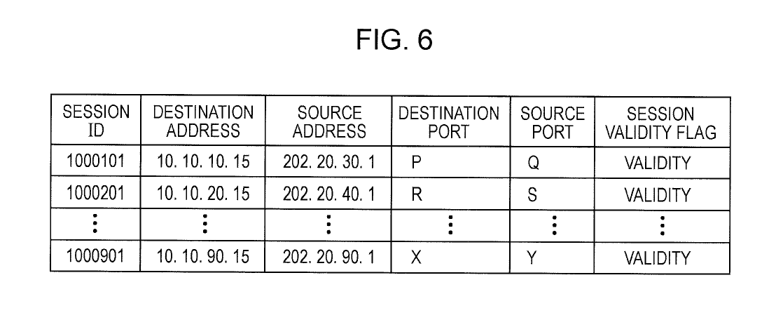

FIG. 6 is a diagram illustrating an example of a session information table, according to an embodiment. Session information is stored in each of records of the session information table 511. The session information table 511 may be configured to include information items of a session ID, a destination address, a source address, a destination port, a source port, and a session validity flag.

The session ID is an identifier (ID) that identifies a session. The destination address is an IP address of a node that is a destination of a packet. The source address is an IP address of a node that is a source of the packet. The destination port is a port that is used by the node that is the destination of the packet.

The source port is a port that is used by the node that is the source of the packet. The session validity flag indicates whether a session is valid, where the value of “validity” indicates that the session is valid, and the value of “invalidity” indicates that the session is invalid. The FWs 501-2 and 501-3 each have the same functions or configurations as the FW 501-1, and descriptions thereof are omitted here.

Next, description will be given of the flow of operations from distribution of a request packet to distribution of a response packet.

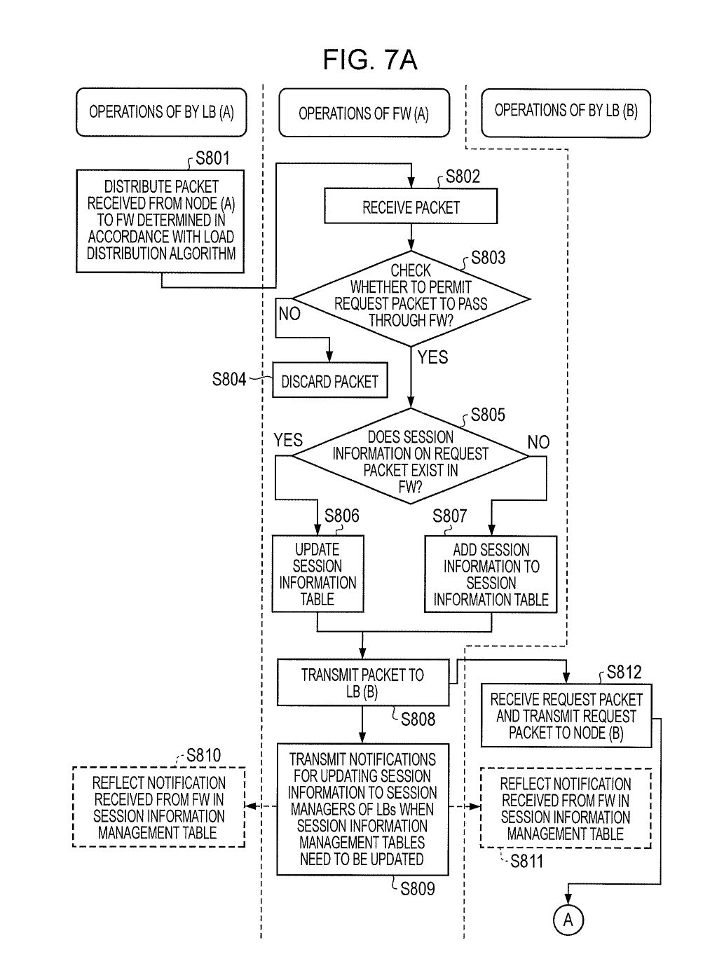

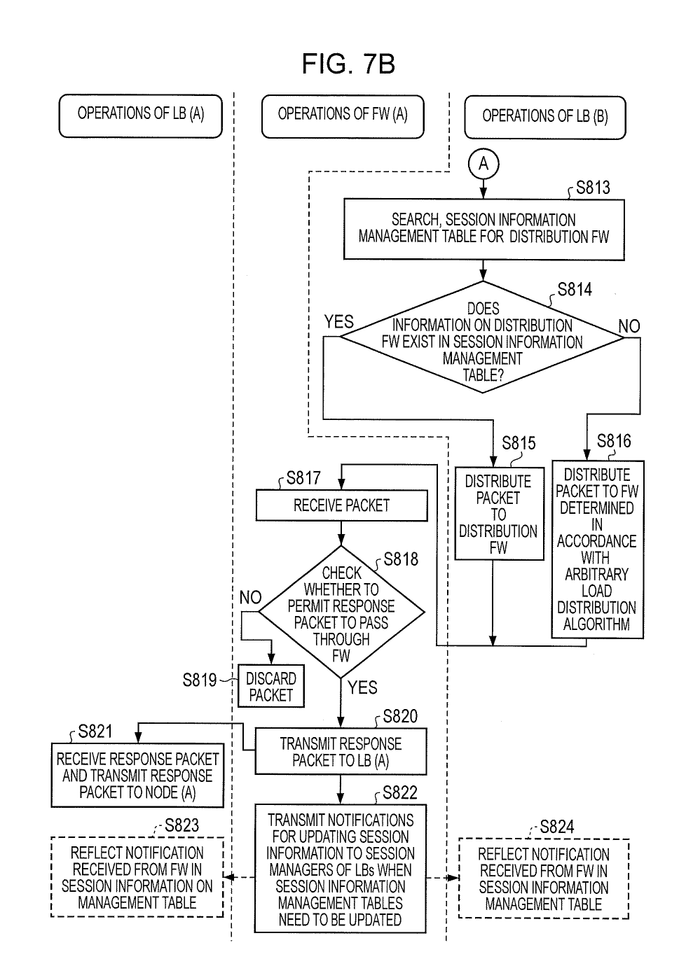

FIGS. 7A and 7B are diagrams illustrating an example of an operational flowchart for a distribution process, according to an embodiment. In FIGS. 7A and 7B, a flowchart depicted on the leftmost side indicates operations to be performed by the LB 401-1, a flowchart depicted in the middle indicates operations to be performed by the FW 501-1, and a flowchart depicted on the rightmost side indicates operations to be performed by the LB 401-2.

Description will be given of an example in which the node 201-1 transmits a request packet (communication request) to the node 201-2 and receives, from the node 201-2, a response packet in response to the request packet.

First, the node 201-1 transmits the request packet to the node 201-2. The request packet reaches the LB 401-1 through the Internet 601 and the router 301-1.

In operation S801, the packet transceiver 408-1 of the LB 401-1 receives the request packet, and the load distribution policy manager 407-1 determines a firewall to which the request packet is to be distributed, using an arbitrary load distribution algorithm. In the case, it is assumed that the load distribution policy manager 407-1 determines the FW 501-1 to be the firewall to which the request packet is to be distributed. Then the packet transceiver 408-1 transmits the request packet to the FW 501-1.

In operation S802, the packet transceiver 502 of the FW 501-1 receives the request packet.

In operation S803, the packet checker 508 of the FW 501-1 performs packet check processing on the request packet. For example, the packet checker 508 determines whether to permit the request packet to pass through the FW 501-1. When the packet checker 508 determines to permit the request packet to pass through the FW 501-1 (YES in operation S803), the control proceeds to operation S805. When the packet checker 508 does not determine to permit the request packet to pass through the FW 501-1 (NO in operation S803), the process proceeds to operation S804. Here, the packet checker 508 determines whether to permit the request packet to pass through the FW 501-1, by determining whether or not information such as a source address and a source port that are included in the request packet satisfies a predetermined requirement.

In operation S804, the packet checker 508 discards the request packet.

In operation S805, the session information manager 504 determines whether or not the session information table 511 stores a record storing session information on the received request packet. When the session information table 511 stores the corresponding record (YES in operation S805), the process proceeds to operation S806. When the session information table 511 does not store the corresponding record (NO in operation S805), the process proceeds to operation S807.

In operation S806, the session information manager 504 updates the session information table 511.

In operation S807, the session information manager 504 adds a record storing the session information on the request packet to the session information table 511. For example, the session information manager 504 stores a destination address, a source address, a destination port, and a source port contained in the received request packet, in the fields of the destination address, the source address, the destination port, and the source port of the corresponding record in the session information table 511, respectively. The session information manager 504 further stores the assigned identifier in a session ID field of the corresponding record in the session information table 511, and sets value “validity” to a field of the session validity flag of the corresponding record in the session information table 511.

In operation S808, the packet transceiver 502 transmits the request packet to the LB 401-2.

In operation S809, when the session information management tables 411-1 and 411-2 need to be updated, the session information notifier 505 transmits notifications for updating session information to the session managers 405-1 and 405-2 of the LBs 401-1 and 401-2. In the case, it is assumed that the session information on the request packet is added to the session information table 511 and the notifications for updating the session information are transmitted to the LBs 401-1 and 401-2. Next, description will be given of a notification for updating session information.

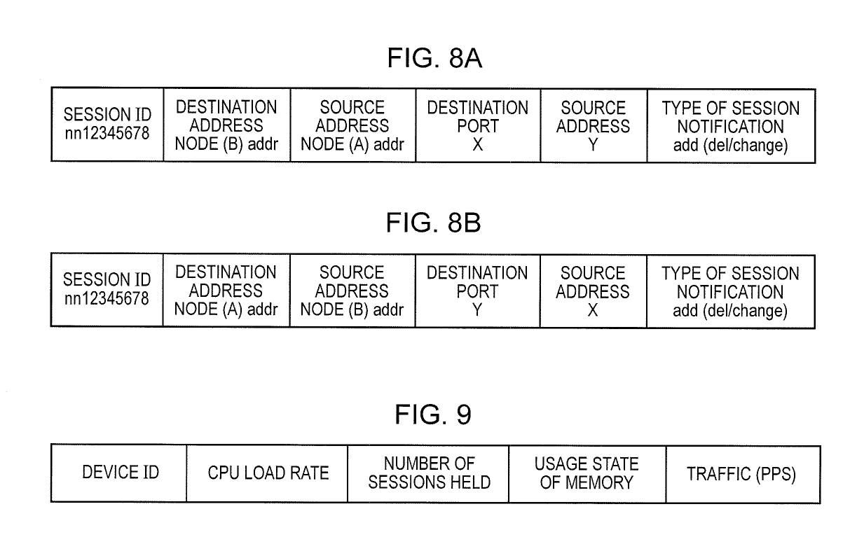

FIG. 8A is a diagram illustrating an example of a notification for updating session information, according to an embodiment. For example, the notification is transmitted to the LB 401-1 in order to update the session information. FIG. 8B is a diagram illustrating an example of a notification for updating session information, according to an embodiment. For example, the notification is transmitted to the LB 401-2 in order to update the session information.

Each of the notifications for updating session information includes a session ID, a destination address, a source address, a destination port, a source port, and a type of the session notification.

The session ID is an identifier (ID) that identifies a session. The destination address is an IP address of the node that is the destination of the packet. The source address is an IP address of the node that is the source of the packet. The destination port is a port that is used by the node that is the destination of the packet. The source port is a port that is used by the node that is the source of the packet.

The type of session notification indicates a type of the notification for updating the session information. For example, as the type of the session notification, “add” indicating addition, “del” indicating deletion, or “change” indicating deletion may be stored. A LB 401 references the types of the session notifications, and adds the session information to the session information management table 411, delete the session information from the session information management table 411, or change the session information of the session information management table 411.

In the case, in the notification transmitted to the LB 401-1 in order to update the session information, for example, the session ID is “nn12345678”, the destination address is an address of the node 201-2, the source address is an address of the node 201-1, the destination port is a port number of the node 201-2, the source port is a port number of the node 201-1, and the type of the session notification is “add”.

In the case, in the notification transmitted to the LB 401-2 in order to update the session information, for example, the session ID is “nn12345678”, the destination address is the address of the node 201-1, the source address is the address of the node 201-2, the destination port is the port number of the node 201-1, the source port is the port number of the node 201-2, and the type of the session notification is “add”.

Referring back to FIG. 7A, in operation S810, the session information receiver 402-1 of the LB 401-1 receives the notification for updating the session information, and the session manager 405-1 updates the session information management table 412-1 on the basis of the notification for updating the session information.

In the case, the session information receiver 402-1 stores information identifying the FW 501-1 in a field of the distribution destination in the session information management table 412-1 where the FW 501-1 is the source of the notification for updating the session information. The session information receiver 402-1 stores the session ID, the destination address, the source address, the destination port, and the source port, which are contained in the notification, in record fields of the session ID, the destination address, the source address, the destination port, and the source port in the session information management table 412-1, respectively. Further, the session information receiver 402-1 stores information indicating “validity” in a record field of the session validity flag in the session information management table 412-1.

In operation S811, the session information receiver 402-2 of the LB 401-2 receives a notification for updating the session information, and the session manager 405-2 updates the session information management table 412-2 on the basis of the notification for updating the session information.

In the case, the session information receiver 402-2 stores information identifying the FW 501-1 in a record field of the distribution destination in the session information management table 412-2 where the FW 501-1 is the source of the notification for updating the session information. The session information receiver 402-2 stores the session ID, the destination address, the source address, the destination port, and the source port, which are contained in the notification, in record fields of the session ID, the destination address, the source address, the destination port, and the source port in the session information management table 412-2, respectively. Further, the session information receiver 402-2 stores information indicating “validity” in a record field of the session validity flag in the session information management table 412-2.

In the case, it is assumed that the session information receiver 402-2 of the LB 401-2 receives the notification (illustrated in FIG. 8B) for updating the session information and updates the session information management table 412-2. Thus, the session information indicating that the distribution destination of the packet transmitted from the node 201-2 to the node 201-1 is the FW 501-1 is stored in the session information management table 412-2.

In operation S812, the packet transceiver 408-2 of the LB 401-2 receives the request packet and transmits the request packet to the node 201-2. The node 201-2 receives the request packet and executes various processes. Then, in response to the request packet, the node 201-2 transmits a response packet for the node 201-1 to the LB 401-2.

In operation S813, when the packet transceiver 408-2 of the LB 401-2 receives the response packet, the distribution firewall (FW) inquirer 406-2 searches the session information management table 411-2 for a distribution firewall to which the response packet is to be distributed. For example, the distribution firewall (FW) inquirer 406-2 searches the session information management table 411-2 using, as search keys, attribute information of the response packet, that is, information on a destination address, a source address, a destination port, and a source port. Then, the distribution firewall (FW) inquirer 406-2 detects, from the session information management table 411-2, a firewall identified by a record field of the distribution destination that is stored in a record matching the search keys, as the distribution firewall to which the response packet is to be distributed. When the distribution firewall to which the response packet is to be distributed is detected, the distribution firewall (FW) inquirer 406-2 notifies the session manager 405-2 of the detected distribution firewall to which the response packet is to be distributed.

In operation S814, when the distribution firewall to which the response packet is to be distributed is detected in the operation S813 (YES in operation S814), the process proceeds to operation S815. When the distribution firewall to which the response packet is to be distributed is not detected (NO in operation S814), the process proceeds to operation S816.

In operation S815, the session manager 405-2 distributes the response packet to the detected distribution firewall via the packet transceiver 408-2.

Since the request packet has been distributed to the FW 501-1 as described above, it is assumed in the case that the FW 501-1 is detected as the distribution firewall to which the response packet is to be distributed and the response packet is distributed to the FW 501-1.

In operation S816, the load distribution policy manager 407-2 determines one of FWs 501 to which the response packet is to be distributed by using an arbitrary load distribution algorithm. Then, the packet transceiver 408-2 transmits the response packet to the determined one of the FWs 501.

In operation S817, the packet transceiver 502 of the FW 501-1 receives the response packet.

In operation S818, the packet checker 508 performs packet check processing on the response packet. That is, the packet checker 508 determines whether to permit the response packet to pass through the FW 501-1. When the packet checker 508 determines that the response packet is permitted to pass through the FW 501-1 (YES in operation S818), the process proceeds to operation S820. When the packet checker 508 does not permit the response packet to pass through the FW 501-1 (NO in operation S818), the process proceeds to operation S819. Note that the packet checker 508 determines whether to permit the response packet to pass through the FW 501-1, by determining whether or not there exists session information on the response packet in the session information table 511. When there exists the session information corresponding to the response packet in the session information table 511, that is, when a request packet corresponding to the response packet has previously passed through the FW 501-1, the packet checker 508 determines that the response packet responsive to the request packet is permitted to pass through the FW 501-1.

In operation S819, the packet checker 508 discards the received response packet.

In operation S820, the packet transceiver 502 transmits the received response packet to the LB 401-1.

In operation S821, the packet transceiver 408-1 of the LB 401-1 receives the response packet and transmits the received response packet to the node 201-1.

In operation S822, when the session information management tables 411-1 and 411-2 need to be updated, the session information notifier 505 transmits notifications for updating session information to the session managers 405-1 and 405-2 of the LBs 401-1 and 401-2, respectively.

In operation S823, the session information receiver 402-1 of the LB 401-1 receives the notification for updating the session information, and the session manager 405-1 updates the session information management table 411-1 on the basis of the received notification for updating the session information.

In operation S824, the session information receiver 402-2 of the LB 401-2 receives the notification for updating the session information, and the session manager 405-2 updates the session information management table 411-2 on the basis of the received notification for updating the session information.

Next, description will be given of collecting device information, distribution of a process to another firewall, and a process of taking over information when a firewall becomes inoperative due to a failure of the firewall. First, description is given of collecting device information.

A device information collector 404 of a LB 401 periodically requests a device information notifier 507 of a FW 501 to transmit notifications indicating the device information. Upon receiving the requests, the device information notifier 507 of the FW 501 transmits the device information to the device information collector 404 of the LB 401.

FIG. 9 is a diagram illustrating an example of device information, according to an embodiment. The device information, which is transmitted from each of the device information notifiers 507 to the device information collectors 404, may be configured, for example, to include information items of a CPU load rate, the number of sessions held, a usage state of a memory, and traffic (PPS).

The CPU load rate indicates a usage rate of a central processing unit (CPU) of the firewall. The number of sessions held indicates the number of sessions held by the firewall. The usage state of the memory indicates a usage rate of the memory of the firewall. The traffic (PPS) indicates the number of packets to be processed per second by the firewall where a unit of the traffic is a packet per second (PPS).

The device information collector 404 of a LB 401 that has received the device information reflects the received device information in the device information table 412 of the LB 401. For example, the device information collectors 404 store the IDs (identifiers) identifying the firewall that is the sources of the device information, in a record field of a device ID in the device information tables 412. Further, the device information collectors 404 store a CPU load rate, the number of sessions held, a usage state of memory, and traffic (PPS), which are included in the device information, in record fields of the CPU load rate, the number of session held, the usage state of memory, and the traffic (PPS) in the device information tables 412.

Next, description will be given of the distribution of a process to another firewall and the process for taking over information. A process to be executed when the LB 401-1 detects an abnormality is described bellow.

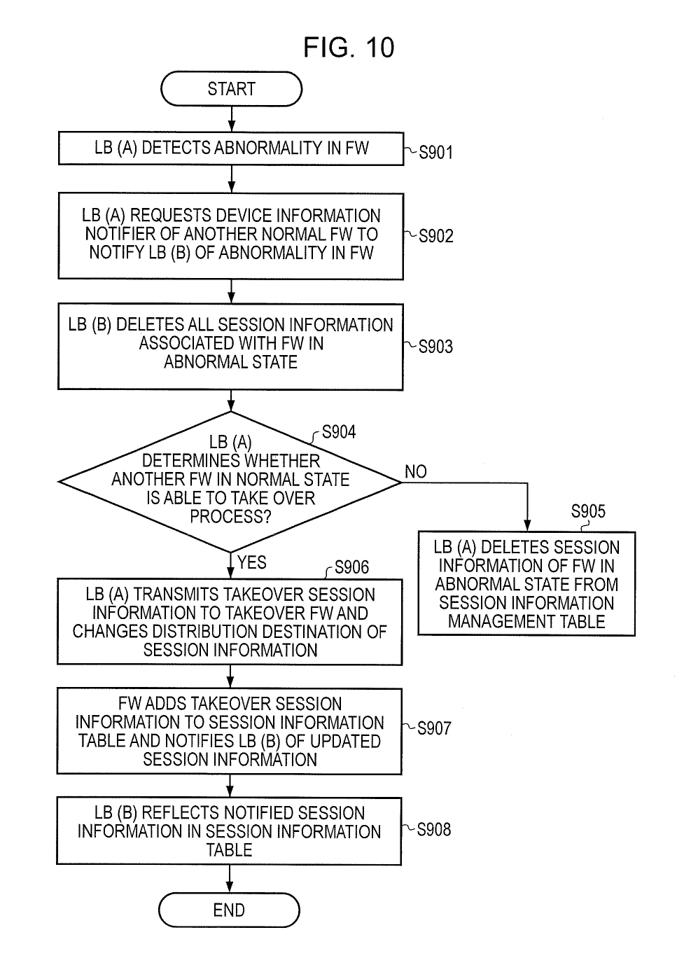

FIG. 10 is a diagram illustrating an example of an operational flowchart for a take-over process, according to an embodiment. In the case, it is assumed that the device information collector 404-1 periodically collects device information from the FWs 501 (FWs 501-1 to 501-3).

In operation S901, the device information collector 404-1 of a LB 401-1 detects an abnormality in an FW 501 among the FWs 501. In this case, the device information collector 404-1 detects the abnormality, based on the device information transmitted from the FW 501. For example, when the device information is not notified from the FW 501 to the LB 401-1, or when a CPU load rate or the amount of traffic that is included in the device information is an abnormal value, the device information collector 404-1 determines that the abnormality has been detected. In this case, it is assumed that an abnormality of the FW 501-2 has been detected.

In operation S902, the session manager 405-1 requests the device information notifier 507 of another firewall FW 501 in a normal state to notify the LB 401-2 of the abnormality in the FW 501-2. Upon another firewall FW 501 receives the request, the device information notifier 507 of the another firewall FW 501 notifies the LB 401-2 of the LB 401-2 of the abnormality in the FW 501-2.

In operation S903, the session information receiver 402-2 of the LB 401-2 receives the notification indicating the abnormality in the FW 501-2, and the session manager 405-2 deletes, from the session information management table 411-2, a record storing the distribution destination identifying the FW 501-2 in an abnormal state, that is, a record associated with the FW 501-2 in an abnormal state.

In operation S904, the session manager 405-1 the LB 401-1 determines whether or not the another FW 501 in a normal state, for example, the FW 501-1, is able to take over a process of the FW 501-2 in an abnormal state.

The session manager 405-1 the LB 401-1 calculates a load to be imposed on another FW 501 when the another FW 501 takes over the process of the FW 501-2. The session manager 405-1 of the LB 401-1 determines, based on the calculated load, whether or not the another firewall (for example, the FW 501-1) is able to take over the process. As the load, for example, a CPU load rate, the number of sessions held, or a usage state of a memory may be used.

For example, when the process of the FW 501-2 in an abnormal state is taken over and the CPU load rate of the FW 501-1, the number of sessions held by the FW 501-1 or the usage state of the memory of the FW 501-1 is equal to or larger than a predetermined threshold, the session manager 405-1 determines that the FW 501-1 does not have a sufficient resource and is not able to take over the process of the FW 501-2. Meanwhile, when the process of the FW 501-2 in an abnormal state is taken over and the CPU load rate of the FW 501-1, the number of sessions held by the FW 501-1, or the usage state of the memory of the FW 501-1 is smaller than the predetermined threshold, the session manager 405-1 determines that the FW 501-1 has a sufficient resource and is able to take over the process of the FW 501-2.

The CPU load rate, the number of sessions held, and the usage state of the memory when the process is taken over may be calculated from information that is stored in the device information table 412-1 in association with each of the FWs 501.

When it is determined that another firewall FW 501 in a normal state is able to take over the process of the FW 501-2 in an abnormal state (YES in operation S904), the process proceeds to operation S906. Meanwhile, when it is determined that the another FW 501 in a normal state is unable to take over the process of the FW 501-2 in an abnormal state (NO in operation S904), the process proceeds to operation S905.

In the case, it is assumed that the session manager 405-1 of the LB 401-1 determines whether or not the FW 501-1 is able to take over the process of the FW 501-2 and determines that the FW 501-1 is able to take over the process of the FW 501-2. Herein after, a firewall that is able to take over the process will be also referred to as a “takeover firewall”.

In operation S905, the session manager 405-1 deletes, from the session information management table 411-1, a record associated with the distribution destination identifying the FW 501-2 that is in the abnormal state.

In operation S906, the session manager 405-1 transmits takeover session information to the takeover firewall, that is, to the FW 501-1, through the session information notifier 403-1, where the takeover session information indicates session information included in one or more records that are included in the session information management table 411-1 and are associated with the distribution destination identifying the FW 501-2. The takeover session information includes a session ID, a destination address, a source address, a destination port, a source port, and a session validity flag.

Then, the session manager 405-1 changes, to the FW 501-1 (the takeover firewall), the distribution destinations of the one or more record that are included in the session information management table 411-1 and are associated with the distribution destination identifying the FW 501-2.

In operation S907, the session information receiver 506 of the takeover firewall FW 501-1 receives the take-over session information, and the session information manager 504 thereof adds the received take-over session information to the session information table 511. For example, the session information receiver 506 stores, in the session information table 511, a record including the session ID, the destination address, the source address, the destination address, the source address, and the session validity flag that are contained in the received takeover session information.

The session information notifier 505 notifies the LB 401-2 of the session information added to the session information table 511 of the FW 501-1. The notification for the added session information has the same structure as a notification (transmitted in operation S809) for updating the session information.

In operation S908, the session information receiver 402-2 of the LB 401-2 receives the notification, and the session manager 405-2 reflects the received notification in the session information management table 411-2.

In the case, the session information receiver 402-2 of the LB 401-2 stores information identifying the FW 501-1 that is the source of the notification, in a record field of the distribution destination in the session information management table 412-2. Further, the session information receiver 402-2 stores a session ID, a destination address, a source address, a destination port, and a source port that are included in the notification, in record fields of the session ID, the destination address, the source address, the destination port, and the source port in the session information management table 412-2. Further, the session information receiver 402-2 stores information indicating “validity” in a record field of the session validity flag in the session information management table 412-2.

The aforementioned process allows a takeover firewall to take over session information included in a failed firewall and to execute the same process as the packet check processing that has been performed on the response packet by the failed firewall using the session information taken over. Further, each of LBs is able to distribute a packet that has been distributed to the failed firewall, to the takeover firewall.

Thus, even if a firewall fails, the system is able to continuously operate. According to the embodiment, a LB is able to distribute a response packet to a firewall through which a request packet corresponding to the response packet has passed.

Thus, it is unnecessary to synchronize pieces of session information held by firewalls with each other, thereby reducing a communication load and the amount of a memory to be used. As a result, a load to be imposed on a firewall is reduced.

The LBs according to the embodiment enables a normal firewall to take over a process assigned to a failed firewall. Thus, even when the firewall fails, the system may continuously operate, thereby improving a fault tolerance of the system.

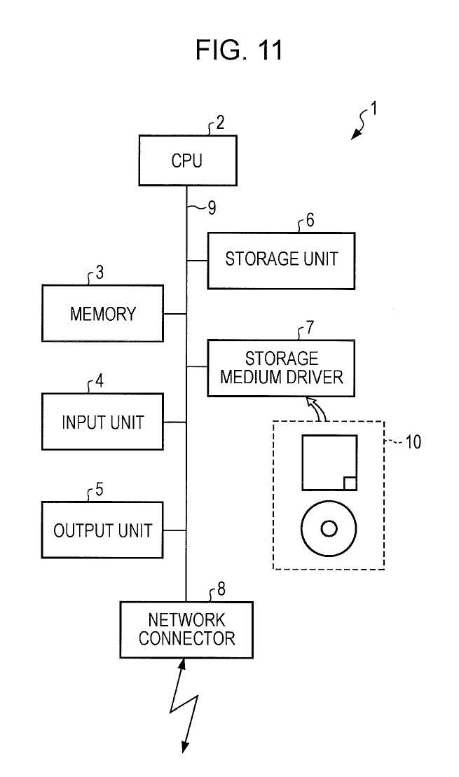

FIG. 11 is a diagram illustrating an example of a hardware configuration of an information processing device, according to an embodiment. For example, a LB 401 and a FW 501 according to the embodiment may be implemented using a information processing device 1 illustrated in FIG. 11.

The information processing device 1 includes a central processing unit (CPU) 2, a memory 3, an input unit 4, an output unit 5, a storage unit 6, a storage medium driver 7, and a network connecter 8, which are connected to each other through a bus 9.

The CPU 2 controls the whole information processing device 1. The CPU 2 may perform processes corresponding to the session information receivers 402-1, 402-2, the session information notifiers 403-1, 403-2, the device information collectors 404-1, 404-2, the session managers 405-1, 405-2, the distribution firewall (FW) inquirers 406-1, 406-2, the load distribution policy managers 407-1, 407-2, the packet transceivers 408-1, 408-2, the packet transceiver 502, the timer manager 503, the session information manager 504, the session information notifier 505, the session information receiver 506, the device information notifier 507, and the packet checker 508 of FIG. 3.

The memory 3 is a memory, such as a read only memory (ROM) or a random access memory (RAM), that temporarily stores programs or data stored in the storage unit 6 (or a portable storage medium 10). The CPU 2 performs the aforementioned processes by executing the programs using the memory 3.

In this case, program codes read from the portable storage medium 10 or the like may implement the functions according to the embodiment. The input unit 4 may be implemented, for example, using a keyboard, a mouse, or a touch panel. The output unit 5 may be implemented, for example, using a display or a printer.

The storage unit 6 may be implemented, for example, using a magnetic disk device, an optical disc device, or a tape device. The information processing device 1 stores the aforementioned programs and the aforementioned data in the storage unit 6, and uses the programs and the data by loading the programs and the data into the memory 3. The storage unit 6 corresponds to the storage units 409-1, 409-2, and 509 of FIG. 3.

The storage medium driver 7 drives the portable storage medium 10 and accesses data stored in the portable storage medium 10. As the portable storage medium 10, an arbitrary computer-readable storage medium such as a memory card, a flexible disk, a compact disk read only memory (CD-ROM), an optical disc, or a magneto-optical disc may be used. A user may store the aforementioned programs and the aforementioned data in the portable storage medium 10 and use the programs and the data by loading them into the memory 3. The network connecter 8 may be connected to an arbitrary communication network such as a LAN and execute data conversion for communication.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An apparatus for distributing load among a plurality of communication devices, the apparatus comprising:
a memory to store a session information management table that stores session information for a request packet in association with one of the plurality of communication devices via which the request packet has been transmitted to the apparatus; and
a processor to:
receive a first response packet in response to a first request packet that has been transmitted via a first communication device included in the plurality of communication devices, the first response packet sharing first session information with the first request packet,
select, from among the plurality of communication devices, the first communication device associated with the first session information, by referring to the session information management table, and
transmit the first response packet to the selected first communication device.

2. The apparatus of claim 1, wherein
the processor is further configured to detect abnormal events in the plurality of communication devices; and
when an abnormal event is detected in the first communication device, the processor updates the session information management table so that first attribution information that has been associated with the first communication device is associated with a second communication device in which no abnormal events are detected.

3. The apparatus of claim 2, wherein
the processor transmits the first attribute information to the second communication device before updating the session information management table.

4. The apparatus of claim 1, wherein
the processor is further configured to receive, from the first communication device, the first session information for the first request packet; and
the processor updates the session information management table so that the first session information is associated with the first communication device.

5. A method for distributing a load among a plurality of communication devices, the method being performed by a load balancer communicably coupled to the plurality of communication devices, the method comprising:
providing the load balancer with a session information management table that stores session information for a request packet in association with one of the plurality of communication devices via which the request packet has been transmitted to the load balancer;
receiving a first response packet in response to a first request packet that has been transmitted via a first communication device included in the plurality of communication devices, the first response packet sharing first session information with the first request packet;
selecting, from among the plurality of communication devices, a first communication device associated with the first session information, by referring to the session information management table; and
transmitting the first response packet to the selected first communication device.

6. A computer readable recording medium having stored therein a program for causing a load balancer communicably coupled to a plurality of communication devices to execute a procedure comprising:
providing the load balancer with a session information management table that stores session information for a request packet in association with one of the plurality of communication devices via which the request packet has been transmitted to the load balancer;
receiving a first response packet in response to a first request packet that has been transmitted via a first communication device included in the plurality of communication devices, the first response packet sharing first session information with the first request packet;
selecting, from among the plurality of communication devices, a first communication device associated with the first session information, by referring to the session information management table; and
transmitting the first response packet to the selected first communication device.

7. A system comprising:
a plurality of communication devices; and
first and second load balancers each communicably coupled to the plurality of communication devices, wherein
each of the first and second load balancers is configured to:
store a session information management table that stores session information for a request packet in association with one of the plurality of communication devices via which the request packet has been transmitted to the each load balancer,
receive a first response packet in response to a first request packet that has been transmitted via a first communication device included in the plurality of communication devices, the first response packet sharing first session information with the first request packet,
select, from among the plurality of communication devices, a first communication device associated with the first session information, by referring to the session information management table, and
transmit the first response packet to the selected first communication device;
each of the plurality of communication devices determines whether or not the received request packet is permitted to pass through the each communication device;
the each communication device transmits the session information for the received request packet to at least one of the first and second load balancers when it is determined that the received request packet is permitted to pass through the each communication device; and
each of the first and second load balancers, upon receiving the session information from the each communication device, updates the session information management table so that the received session information is associated with the each communication device.
